(19) United States
(12) Patent Application Publication
(10) Pub. No.: US 2013/0336651 A1
(43) Pub. Date: Dec. 19, 2013

(54) OPTICAL TRANSMISSION APPARATUS AND METHOD

(71) Applicant: FUJITSU LIMITED, Kawasaki-shi (JP)

(72) Inventors: Koji Bato, Fukuoka (JP); Tomoyuki Sakata, Fukuoka (JP); Tatsuro Kishida, Fukuoka (JP)

(73) Assignee: FUJITSU LIMITED, Kawasaki-shi (JP)

(21) Appl. No.: 13/865,570

(22) Filed: Apr. 18, 2013

(30) Foreign Application Priority Data
Jun. 14, 2012 (JP) 2012-134992

(51) Int. Cl. H04B 10/564

(52) U.S. Cl. CPC H04B 10/564
USPC 398/38

(57) ABSTRACT

An optical transmission apparatus includes a splitter configured to split an input optical signal into a first optical signal and a second optical signal, a signal length determiner configured to determine a signal length of the first optical signal per unit time, an optical power detector configured to detect an optical power of the first optical signal per unit time, a delay unit configured to delay the second optical signal, an optical amplifier configured to amplify the second optical signal delayed by the delay unit, a first excitation light source configured to generate an excitation light to be supplied to the optical amplifier, and a first excitation light power adjustor configured to adjust an optical power of the excitation light to be supplied to the optical amplifier in accordance with the signal length of the first optical signal and the optical power of the first optical signal.

### CROSS-REFERENCE TO RELATED APPLICATION

This application is based upon and claims the benefit of priority of the prior Japanese Patent Application No. 2012-134992, filed on Jun. 14, 2012, the entire contents of which are incorporated herein by reference.

### FIELD

The embodiments regarding technologies discussed herein are related to an optical transmission apparatus and an optical transmission method.

### BACKGROUND

An optical amplifier configured to amplify an optical burst signal is used in an optical packet transmission apparatus configured to use an optical burst signal.

In the case where an optical burst signal is input to an optical amplifier, even though the optical amplifier is in a sufficiently excited state just after the optical burst signal is input, since the optical amplifier uses energy to amplify the input optical burst signal, the optical amplifier shifts from the excited state to a lower state as time goes by. As a result, the output power of an output signal from the optical amplifier is high just after the optical burst signal is input, and the output power decreases as time goes by. That is, an optical surge occurs just after the optical burst signal is input. A technology for suppressing this optical surge is proposed (see, for example, Japanese Laid-open Patent Publication No. 9-200145 and Japanese Laid-open Patent Publication No. 2001-352297).

### SUMMARY

According to an aspect of the invention, an optical transmission apparatus includes a splitter configured to split an input optical signal into a first optical signal and a second optical signal, a signal length determiner configured to determine a signal length of the first optical signal per unit time, an optical power detector configured to detect an optical power of the first optical signal per unit time, a delay unit configured to delay the second optical signal, an optical amplifier configured to amplify the second optical signal delayed by the delay unit, a first excitation light source configured to generate an excitation light to be supplied to the optical amplifier, and a first excitation light power adjustor configured to adjust an optical power of the excitation light to be supplied to the optical amplifier in accordance with the signal length of the first optical signal and the optical power of the first optical signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram that illustrates an optical transmission apparatus discussed herein;

FIG. 2 is a schematic diagram that illustrates an optical transmission apparatus according to a first embodiment regarding a technology discussed herein;

FIG. 3 is a schematic diagram that illustrates signals in the optical transmission apparatus according to the first embodiment regarding the technology discussed herein;

FIG. 4 is a schematic diagram that illustrates signals in the optical transmission apparatus according to the first embodiment regarding the technology discussed herein;

FIG. 5 is a schematic diagram that illustrates an optical transmission apparatus according to a second embodiment regarding a technology discussed herein;

FIG. 6 is a schematic diagram that illustrates a modified example of the optical transmission apparatus according to the second embodiment regarding the technology discussed herein;

FIG. 7 is a schematic diagram that illustrates an optical transmission apparatus according to a third embodiment regarding a technology discussed herein; and

FIG. 8 is a schematic diagram that illustrates an optical transmission apparatus according to a fourth embodiment regarding a technology discussed herein.

### DESCRIPTION OF EMBODIMENTS

With regard to an optical surge occurring in an optical packet transmission apparatus configured to use an optical burst signal, it becomes clear that the gain of an optical amplifier changes in accordance with the length of each of optical burst signals and the density of the optical burst signals (the proportion of optical burst signals per unit time) input to the optical amplifier, and consequently, the optical power of an output signal changes.

Hereinafter, preferable embodiments for technologies regarding an optical transmission apparatus that may stabilize the gain of an optical amplifier even in the case where optical burst signals input to the optical amplifier change in terms of length and density will be described with reference to the figures.

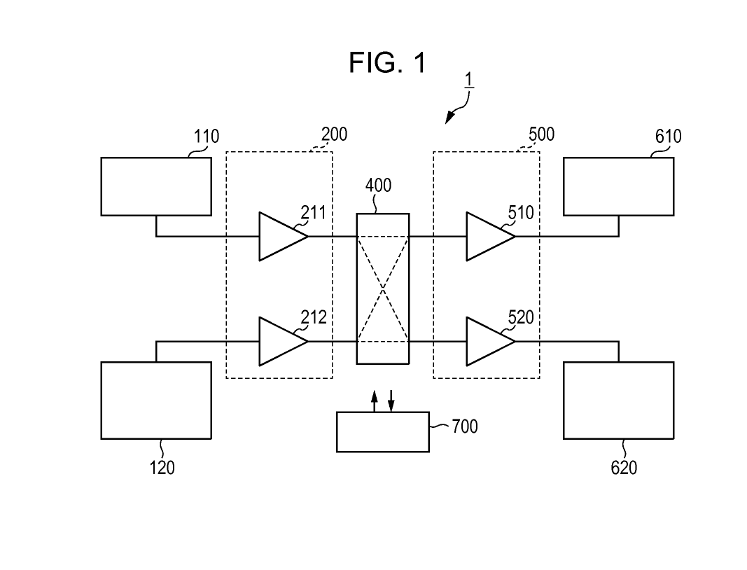

FIG. 1 is a schematic diagram that illustrates an optical transmission apparatus discussed herein. In the first to fourth embodiments described below, an optical packet transmission apparatus 1 configured to use optical burst signals includes an optical burst signal transmission device 120, an optical amplification unit 200, an optical packet switch 400, an optical amplification unit 500, and an optical burst signal receiving device 620. The optical packet transmission apparatus 1 further includes a controller 700. The optical burst signal transmission device 120, the optical amplification unit 200, the optical packet switch 400, the optical amplification unit 500, and the optical burst signal receiving device 620 are controlled by the controller 700. The optical amplification unit 200 includes optical fiber amplifiers 211 and 212. The optical amplification unit 500 includes optical amplifiers 510 and 520. Into the optical packet transmission apparatus 1, an optical burst signal is output from the optical burst signal transmission device 120 or from a wavelength separator (not illustrated) of a wavelength division multiplexing (WDM) transmission device 110 provided in a WDM network. An output optical burst signal is amplified by the optical fiber amplifier 212 or 211, and subsequently a path for the amplified signal is selected by the optical packet switch 400. The optical burst signal is subsequently amplified by the optical amplifier 520 or 510 and the loss caused by the optical packet switch 400 is compensated. Then, the optical burst signal is input to the optical burst signal receiving device 620 or a WDM transmission device 610 provided in the WDM network.

### First Embodiment

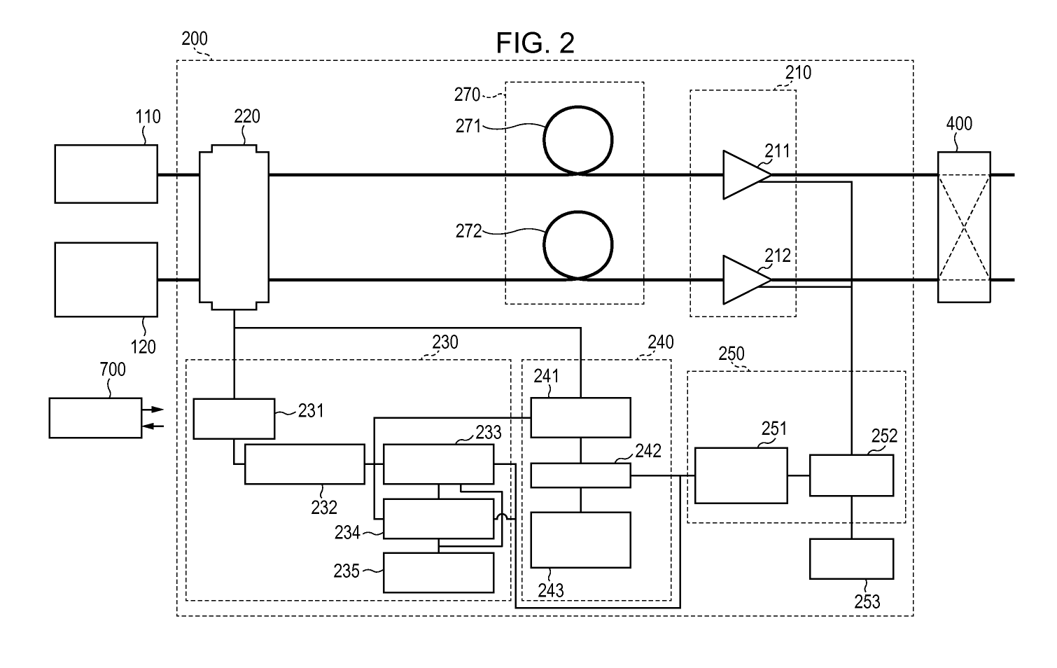

FIG. 2 is a schematic diagram that illustrates an optical transmission apparatus regarding a technology discussed herein. The optical amplification unit 200 includes an optical splitter 220, an optical burst signal monitor 230, a power detector 240, an excitation laser output controller 250, an excitation laser 253, an optical delay unit 270, and an optical fiber amplification unit 210.

The optical splitter 220 is provided between the optical burst signal transmission device 120 and the optical delay unit 270 and between the WDM transmission device 110 and the optical delay unit 270, and connected to the optical burst signal monitor 230 and the power detector 240.

The optical burst signal monitor 230 includes a photo detector 231, a differentiator 232, a signal length determiner 233, a signal density determiner 234, and a supervisory timer 235. The photo detector 231 is connected to the optical splitter 220. The differentiator 232 is connected to the photo detector 231. The signal length determiner 233 and the signal density determiner 234 are connected to the differentiator 232. The supervisory timer 235 is connected to the signal length determiner 233 and the signal density determiner 234.

The power detector 240 includes a photo detector 241, a comparator 242, and a reference power-value generator 243. The photo detector 241 is connected to the optical splitter 220 and the differentiator 232. The comparator 242 is connected to the photo detector 241 and the reference power-value generator 243.

The excitation laser output controller 250 includes an optical switch 252 and an optical switch controller 251. The optical switch controller 251 is connected to the signal length determiner 233, the signal density determiner 234, the comparator 242, and the optical switch 252.

The optical delay unit 270 includes delay fibers 271 and 272. The delay fibers 271 and 272 are each connected to the optical splitter 220.

The optical fiber amplification unit 210 includes the optical fiber amplifiers 211 and 212. The optical fiber amplifiers 211 and 212 are connected to the delay fibers 271 and 272, respectively. An erbium doped fiber (EDF) amplifier is used as each of the optical fiber amplifiers 211 and 212 in this embodiment. An excitation laser beam output from the excitation laser 253 enters each of the optical fiber amplifiers 211 and 212 via the optical switch 252.

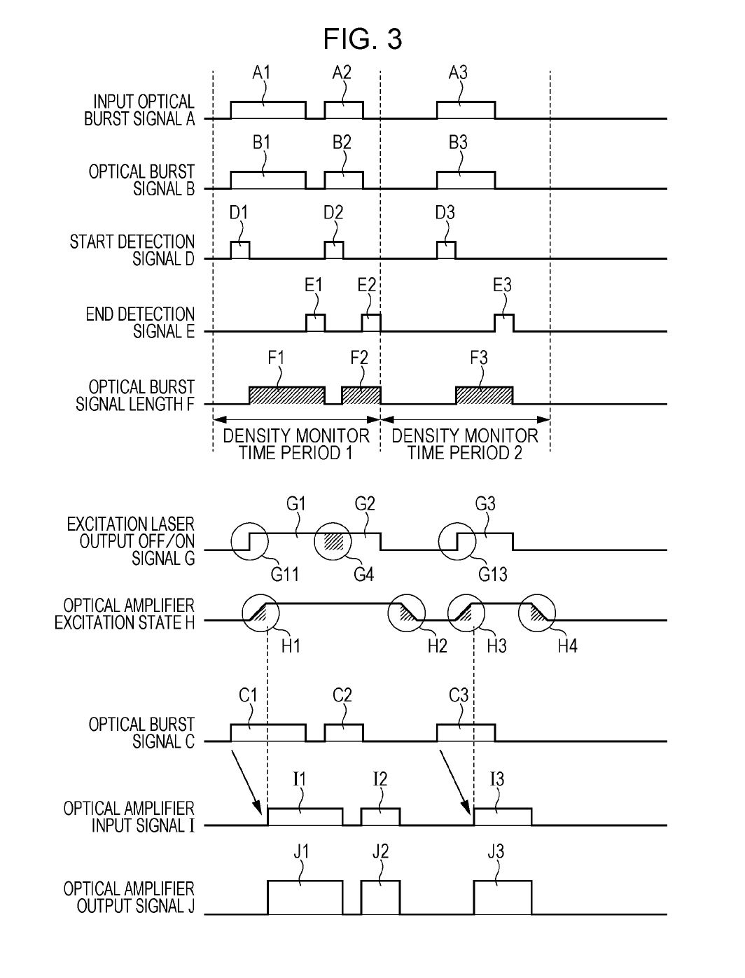

FIG. 3 is a schematic diagram that illustrates signals in the optical transmission apparatus regarding the technology discussed herein. An operation of the optical amplification unit 200 will be described with reference to FIG. 3.

The optical splitter 220 receives optical burst signals A (A1, A2, and A3) output from the optical burst signal transmission device 120 or from the WDM transmission device 110, and outputs optical burst signals B (B1, B2, and B3) and optical burst signals C (C1, C2, and C3). The optical burst signal A1 is split into the optical burst signals B1 and C1. The optical burst signal A2 is split into the optical burst signal B2 and C2. The optical burst signal A3 is split into the optical burst signal B3 and C3. The optical burst signals B, which are further split by the optical splitter 220, are output to the photo detector 231 of the optical burst signal monitor 230 on one hand and to the photo detector 241 of the power detector 240 on the other hand. The optical burst signals C, which are split by the optical splitter 220, are output to the optical delay unit 270. More specifically, the optical burst signals A output from the optical burst signal transmission device 120 are input to the optical splitter 220 and the optical burst signals B and C are output from the optical splitter 220. The optical burst signals B, which are output from the optical splitter 220, are input to the photo detector 231 on one hand and to the photo detector 241 on the other hand. The optical burst signals C, which are output from the optical splitter 220, are input to the delay fiber 272 of the optical delay unit 270. The optical burst signals A output from the WDM transmission device 110 are input to the optical splitter 220 and the optical burst signals B and C are output from the optical splitter 220. The optical burst signals B, which are output from the optical splitter 220, are input to the photo detector 231 on one hand and to the photo detector 241 on the other hand. The optical burst signals C, which are output from the optical splitter 220, are input to the delay fiber 271 of the optical delay unit 270.

The optical burst signal monitor 230, to which the optical burst signals B output from the optical splitter 220 on one hand are input, performs a determination operation for determining the signal lengths, signal intervals, and signal densities (each signal density representing the proportion of optical burst signals each unit time) of the optical burst signals B, which are output from the optical splitter 220 on one hand.

The optical burst signals B are input to the photo detector 231 in the optical burst signal monitor 230 receiving the optical burst signals B. The photo detector 231 detects the optical burst signals B. The detected optical burst signals B are input to the differentiator 232.

The differentiator 232 detects the start and the end of each of the optical burst signals B through detection of rising and falling edges of the optical burst signal B. Start detection signals D (D1, D2, and D3) are generated by detecting the rising edges of the optical burst signals B (B1, B2, and B3), and end detection signals E (E1, E2, and E3) are generated by detecting the falling edges of the optical burst signals B (B1, B2, and B3). The start detection signal D1 is generated by detecting the rising edge of the optical burst signal B1, and the end detection signal E1 is generated by detecting the falling edge of the optical burst signal B1. The start detection signal D2 is generated by detecting the rising edge of the optical burst signal B2, and the end detection signal E2 is generated by detecting the falling edge of the optical burst signal B2. The start detection signal D3 is generated by detecting the rising edge of the optical burst signal B3, and the end detection signal E3 is generated by detecting the falling edge of the optical burst signal B3.

The signal length determiner 233 calculates signal lengths of optical burst signal lengths F (F1, F2, and F3) by using the start detection signals D (D1, D2, and D3) and the end detection signals E (E1, E2, and E3). The signal lengths of optical burst signal length F1 is calculated by using the start detection signal D1 and the end detection signal E1. The signal lengths of optical burst signal length F2 is calculated by using the start detection signal D2 and the end detection signal E2. The signal lengths of optical burst signal length F3 is calculated by using the start detection signal D3 and the end detection signal E3. The signal length determiner 233 also calculates signal intervals of an optical burst signal by using the end detection signal E and the start detection signal D subsequent to the end detection signal E. For example, the signal interval between the optical burst signal B1 and the optical burst signal B2 is calculated by using the end detection signal E1 and the start detection signal D2, which is subsequent to the end detection signal E1. For example, a counter is preferably used as the signal length determiner 233.

The signal density determiner 234 performs a determination operation for determining an optical burst signal density by using the number of times the start detection signals D (D1, D2, and D3) are detected and the optical burst signal lengths F (F1, F2, and F3) per unit time.

Here, the unit time is a density monitor time period in which the optical burst signal density is monitored and which is determined by the supervisory timer 235. In the case where the density monitor time period is too long, optical burst signal densities vary greatly from the average optical burst signal density. In the case where the density monitor time period is too short, output control of the excitation laser is not performed in time or the excitation laser is likely to oscillate because the density monitor time period is close to a time period in which the output control of the excitation laser is performed. Thus, the density monitor time period is set to a time period almost the same as a time period corresponding to the length of the longest optical burst signal (from about ten and several microseconds to about several tens of microseconds) and the output of the excitation laser is controlled in a stepwise manner in accordance with the optical burst signal density per density monitor time period. Here, since a desired performance and the amount of information handled in a transmission network vary from region to region, it is desirable that the density monitor time period is determined in accordance with the average of signal densities, the average of signal lengths, and a statistical distribution.

As described above, the optical burst signal density is determined by using the number of times the start detection signals D are detected and the optical burst signal lengths F per unit time (the density monitor time period). Thus, a time period in which the signal length determiner 233 described above performs a determination operation for determining signal lengths is also determined by the supervisory timer 235. Here, it is desirable that the optical burst signal density is obtained by using the number of optical burst signals per unit time (the density monitor time period) and the optical burst signal lengths F of the optical burst signals. Thus, in order to obtain the number of the optical burst signals, the number of times the end detection signals E are detected may be used instead of the number of times the start detection signals D are detected. The optical burst signal density is the proportion of optical burst signals each unit time (the density monitor time period). Determination of the density monitor time period and the determination operation for determining the optical burst signal density are performed by, for example, the controller 700.

With reference to FIG. 3, a density monitor time period 1 has the same time length as a density monitor time period 2, and the density monitor time periods 1 and 2 are determined by the supervisory timer 235. The density monitor time periods 1 and 2 are set to F0. The start detection signals D detected in the density monitor time period 1 are the start detection signals D1 and D2, and the number of times the start detection signals D are detected is two. The lengths of the optical burst signals B (B1 and B2) determined in the density monitor time period 1 are F1 and F2, respectively. Thus, the optical burst signal density is (F1+F2)/F0 in the density monitor time period 1. Moreover, the start detection signal D detected in the density monitor time period 2 is the start detection signal D3, and the number of times the start detection signals D are detected is one. The length of the optical burst signal B (B3) detected in the density monitor time period 2 is F3. Thus, the optical burst signal density is F3/F0 in the density monitor time period 2.

The power detector 240, to which the optical burst signals B output from the optical splitter 220 on the other hand are input, performs a detection operation for detecting the optical power of only optical burst signals in accordance with burst monitor information supplied from the optical burst signal monitor 230. The photo detector 241 of the power detector 240 receives the start detection signals D (D1, D2, and D3) and end detection signals E (E1, E2, and E3) of the optical burst signals B (B1, B2, and B3) from the differentiator 232 of the optical burst signal monitor 230. The photo detector 241 generates rectangular waves, each of which represents a time period in which an optical burst signal exists, by using the start detection signals D (D1, D2, and D3) and the end detection signals E (E1, E2, and E3), respectively. The photo detector 241 measures, for example, the optical power of the optical burst signal B1 only in the time period in which the optical burst signal B1 exists, the optical power of the optical burst signal B2 only in the time period in which the optical burst signal B2 exists, and the optical power of the optical burst signal B3 only in the time period in which the optical burst signal B3 exists, by using the generated rectangular waves. The comparator 242 compares the value of the measured optical power of each of the optical burst signals B1, B2, and B3 with a reference power value generated by the reference power-value generator 243, and outputs power information obtained as a result of comparison.

The excitation laser output controller 250 performs control of a light beam output from the excitation laser 253 in accordance with monitor information of optical burst signals supplied from the optical burst signal monitor 230 and the power information supplied from the power detector 240. The excitation laser 253 supplies excitation power to the optical fiber amplifiers 211 and 212 of the optical fiber amplification unit 210.

The excitation laser output controller 250 controls Off/On of the output of the excitation laser 253 by using the optical burst signal lengths F (F1, F2, and F3) supplied from the signal density determiner 234 of the optical burst signal monitor 230 and intervals between the optical burst signals. Note that, in the case where the excitation laser 253 itself is turned off or on, the excitation laser does not stabilize until a certain time has passed. The excitation laser 253 remains turned on, and the optical switch controller 251 controls Off/On of the output of the excitation laser 253 from the optical switch 252 by controlling the optical switch 252.

An excitation laser output Off/On signal G used to control Off/On of the output of the excitation laser 253 and supplied from the optical switch controller 251 is basically generated in accordance with the optical burst signal lengths F (F1, F2, and F3). In the case where the excitation laser output Off/On signal G is On (denoted by G11 and G13) as illustrated in an optical amplifier excitation state H, irradiation of the optical fiber amplifiers 211 and 212 with an excitation laser beam output from the excitation laser 253 starts. In the beginning, there are time periods (denoted by H1 and H3) in which excitation is insufficiently performed by the optical fiber amplifiers 211 and 212. Moreover, there are time periods (denoted by H2 and H4) in which excitation is performed by fluorescence after the irradiation of the optical fiber amplifiers 211 and 212 with the excitation laser beam output from the excitation laser 253 finishes. In the case where there is a signal interval between the optical burst signals B that is shorter than a time period obtained by adding a time period (such as H1 and H3) in which excitation is insufficiently performed and a time period (such as H2 and H4) in which excitation is performed by fluorescence, the excitation laser output Off/On signal G remains On (denoted by G4).

The optical delay unit 270 delays the optical burst signals C output from the optical splitter 220. The optical delay unit 270 includes the delay fibers 271 and 272. The optical burst signals C (C1, C2, and C3) supplied from the optical splitter 220 are delayed by the delay fibers 271 and 272 of the optical delay unit 270 so that the optical burst signals C (C1, C2, and C3) enter the optical fiber amplification unit 210 after the excitation laser 253 starts to perform output. The delay fibers 271 and 272 include preferably a single mode fiber, a highly nonlinear fiber, or the like.

The optical burst signals C (C1, C2, and C3) delayed by the delay fibers 271 and 272 serve as optical amplifier input signals I (I1, I2, and I3) and are input to the optical fiber amplifiers 211 and 212 of the optical fiber amplification unit 210. In the case where irradiation of the optical fiber amplifiers 211 and 212 with an excitation laser beam output from the excitation laser 253 starts, in the beginning, there are time periods (denoted by H1 and H3) in which excitation is insufficiently performed by the optical fiber amplifiers 211 and 212. Thus, the optical burst signals C are delayed so that the optical burst signal C1 is input to the optical fiber amplifiers 211 and 212 after the time period (denoted by H1) in which excitation is insufficiently performed by the optical fiber amplifiers 211 and 212 and so that the optical burst signal C3 is input to the optical fiber amplifiers 211 and 212 after the time period (denoted by H3) in which excitation is insufficiently performed by the optical fiber amplifiers 211 and 212.

The optical fiber amplifiers 211 and 212 of the optical fiber amplification unit 210 amplify the optical burst signals C (C1, C2, and C3) delayed by the delay fibers 271 and 272, that is, the optical amplifier input signals I (I1, I2, and I3). The amplified optical amplifier input signals I (I1, I2, and I3) are output as optical amplifier output signals 3 (J1, J2, and J3) from the optical fiber amplifiers 211 and 212.

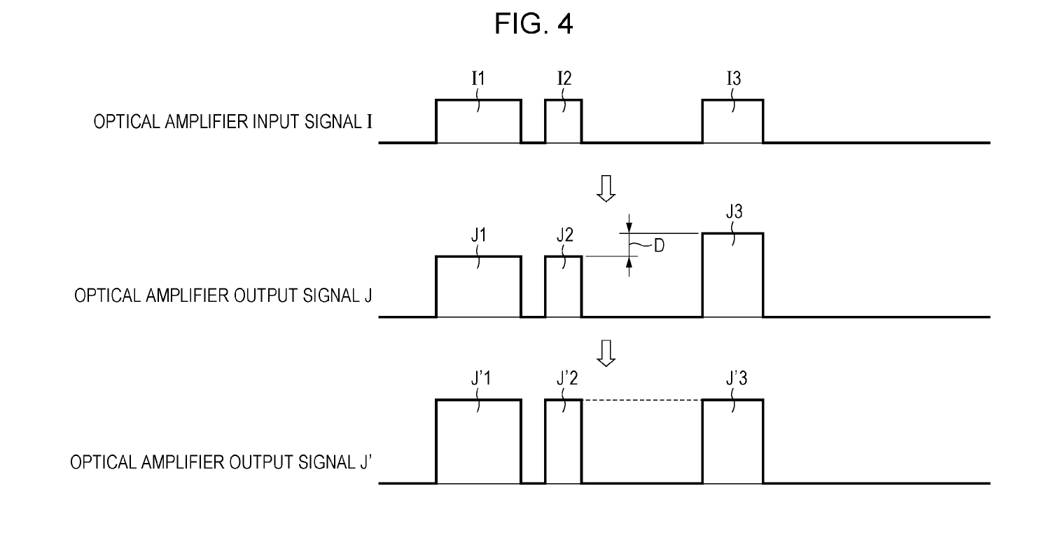

In the case where a signal is input to an optical amplifier such as the optical fiber amplifiers 211 and 212, energy is used to amplify the signal. Therefore, the larger the optical power of the signal is and the higher the signal density of the signal is, the smaller the output of the optical amplifier becomes. As illustrated in FIG. 3, the signal density of the optical burst signals varies since the optical burst signals may exist in a dense manner or in a scattered manner in a transmission line. Moreover, the optical burst signals may be different in terms of optical power. Since the optical amplifier performs amplification in accordance with the average optical power of input signals, there is an optical power difference D between the input and the output of the optical amplifier as illustrated in FIG. 4. Here, it is assumed that all optical burst signals have the same optical power. That is, the optical amplifier input signals I (I1, I2, and I3) have the same optical power. The signal density of the optical amplifier input signals I1 and I2 is high and the signal density of the optical amplifier input signal I3 is low. Thus, in the case where the same optical output power of the excitation laser 253 is used for the optical amplifier input signals I (I1, I2, and I3), the optical power of each of the optical amplifier output signals J1 and J2 is smaller than that of the optical amplifier output signal J3. For this reason, the optical power and signal densities of the optical burst signals are measured; in addition to the above-described controlling Off/On of the output of the excitation laser 253, in the case where the signal density is high, control is performed by increasing the output of the excitation laser 253 so that the optical power difference D decreases and an amplification factor stabilizes. A larger output of the excitation laser 253 is used for the optical amplifier input signals I1 and I2, which have a high signal density, than for the optical amplifier input signal I3, which has a low signal density, and the optical power of optical amplifier output signals J′1 and J′2 become the same as that of an optical amplifier output signal J′3. Here, the optical power of a laser beam output from the excitation laser 253 does not change over time.

More generally, the average optical power of optical burst signals input to an optical amplifier (hereinafter referred to as an “optical amplifier input power average”) is calculated by using a power detection result supplied from the power detector 240 and the signal lengths of the optical burst signals per unit time (the density monitor time period) supplied from the optical burst signal monitor 230. The unit time (the density monitor time period) is set to F0 as described above, and it is assumed that there are, for example, optical burst signals B, the number of which is n, (B1, B2, . . . , and Bn) per unit time (the density monitor time period). The optical burst signals B1, B2, . . . , and Bn have optical power P1, P2, . . . , and Pn, respectively. The optical burst signals B1, B2, . . . , and Bn have signal lengths F1, F2, . . . , and Fn, respectively. The optical amplifier input power average is (P1·F1+P2·F2+ . . . +Pn·Fn)/F0.

A reference value for the optical amplifier input power average is preset. In the case where the optical amplifier input power average is larger than this reference value, the optical switch controller 251 of the excitation laser output controller 250 controls the optical switch 252 so that the optical switch 252 opens, and the amount of the excitation laser beam to be input to the optical amplifier increases. In contrast, in the case where the optical amplifier input power average is smaller than this reference value, the optical switch controller 251 of the excitation laser output controller 250 controls the optical switch 252 so that the optical switch 252 closes, and the amount of the excitation laser beam to be input to the optical amplifier decreases. Such a control is performed by the controller 700.

Here, in the case where the optical burst signals B1, B2, . . . , and Bn have the same optical power (that is, the optical power P1, P2, . . . , and Pn are the same) and the optical power is set to P0, the optical amplifier input power average is P0(F1+F2+ . . . +Fn)/F0. As described above, (F1+F2+ . . . +Fn)/F0 is the signal density (the proportion of the optical burst signals each unit time). Thus, in the case where the optical burst signals have the same optical power, a reference value for the average signal density is preset. In the case where the average signal density is larger than this reference value, the optical switch controller 251 of the excitation laser output controller 250 controls the optical switch 252 so that the optical switch 252 opens, and the amount of the excitation laser beam to be input to the optical amplifier increases. In contrast, in the case where the average signal density is smaller than this reference value, the optical switch controller 251 of the excitation laser output controller 250 controls the optical switch 252 so that the optical switch 252 closes, and the amount of the excitation laser beam to be input to the optical amplifier decreases. Such a control is performed by the controller 700.

An optical switch using a PLZT (Plumbum Lanthanum Zirconate Titanate) thin film or a Mach-Zehnder type optical switch is preferably used as the optical switch 252. Such a switch may change arbitrarily the transmittance thereof in the case where the switch is off in accordance with the transmittance in the case where the switch is on.

### Second Embodiment

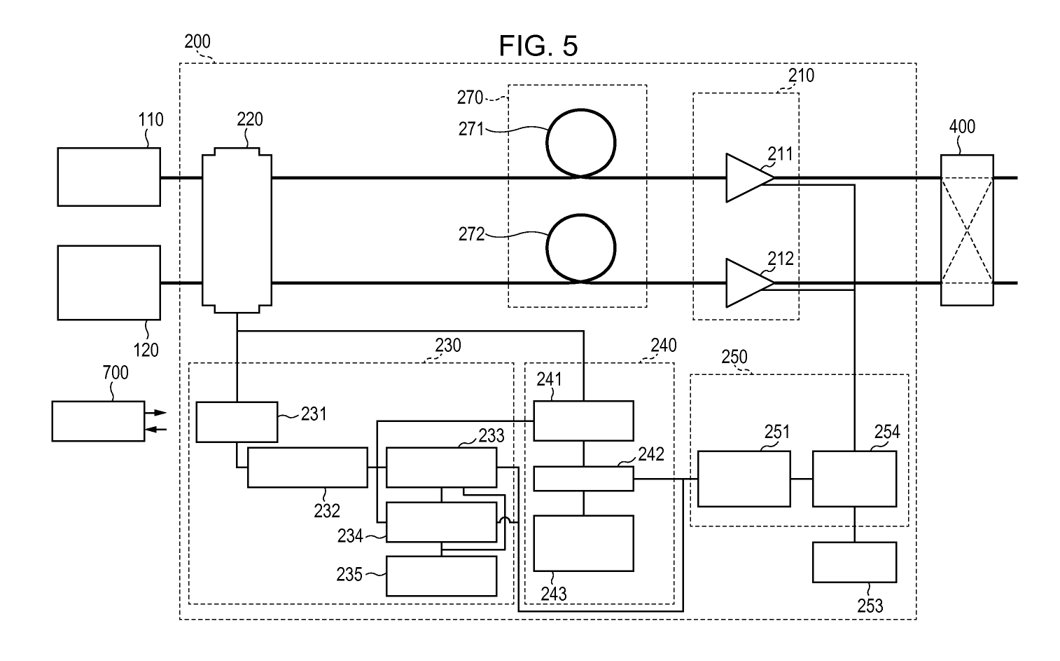

FIG. 5 is a schematic diagram that illustrates an optical transmission apparatus regarding a technology discussed herein. In this embodiment, an acousto-optical switch 254 is used instead of the optical switch 252 of the first embodiment as a switch configured to control the output of the excitation laser 253. The rest of the structure is the same as that of the first embodiment. The acousto-optical switch 254 may change the transmittance thereof in a continuous manner by changing a voltage being applied or a current being supplied thereto.

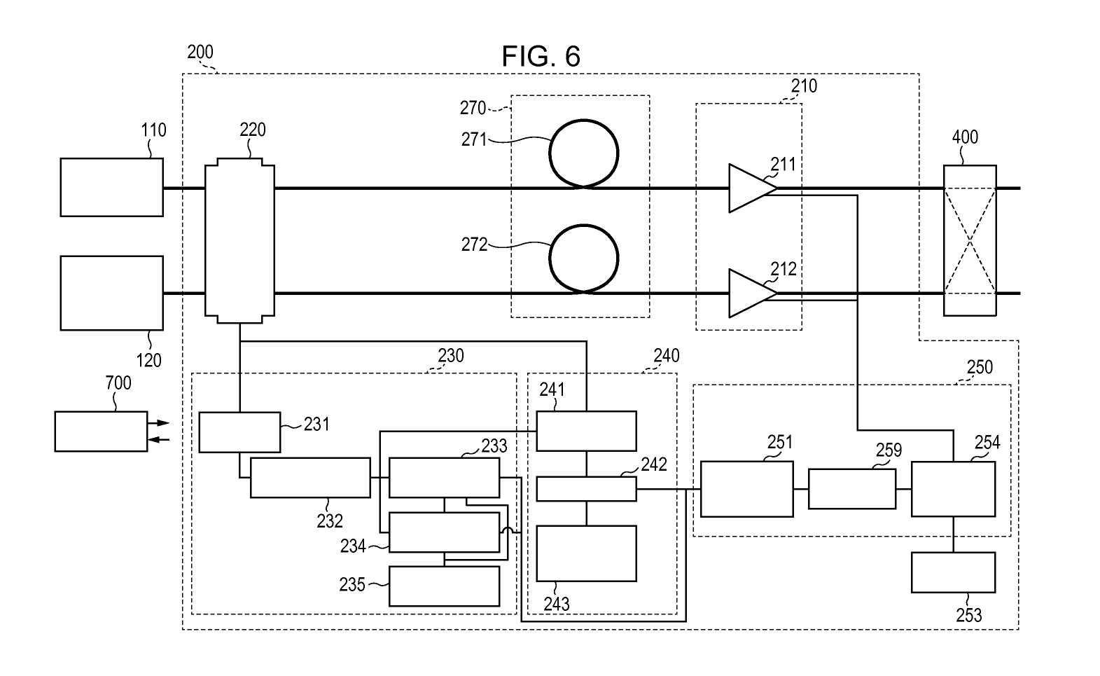

The amount of the excitation laser beam to be input to the optical fiber amplifiers 211 and 212 from the excitation laser 253 may be continuously changed by also using a digital to analog (DA) converter 259 or the like, in accordance with a signal supplied from the power detector 240 as illustrated in FIG. 6. As a result, the amount of the laser beam to be input to the optical fiber amplifiers 211 and 212 from the excitation laser 253 may be increased without stopping input of the excitation laser beam to the optical fiber amplifiers 211 and 212. The DA converter 259 is inserted between the optical switch controller 251 and the acousto-optical switch 254.

### Third Embodiment

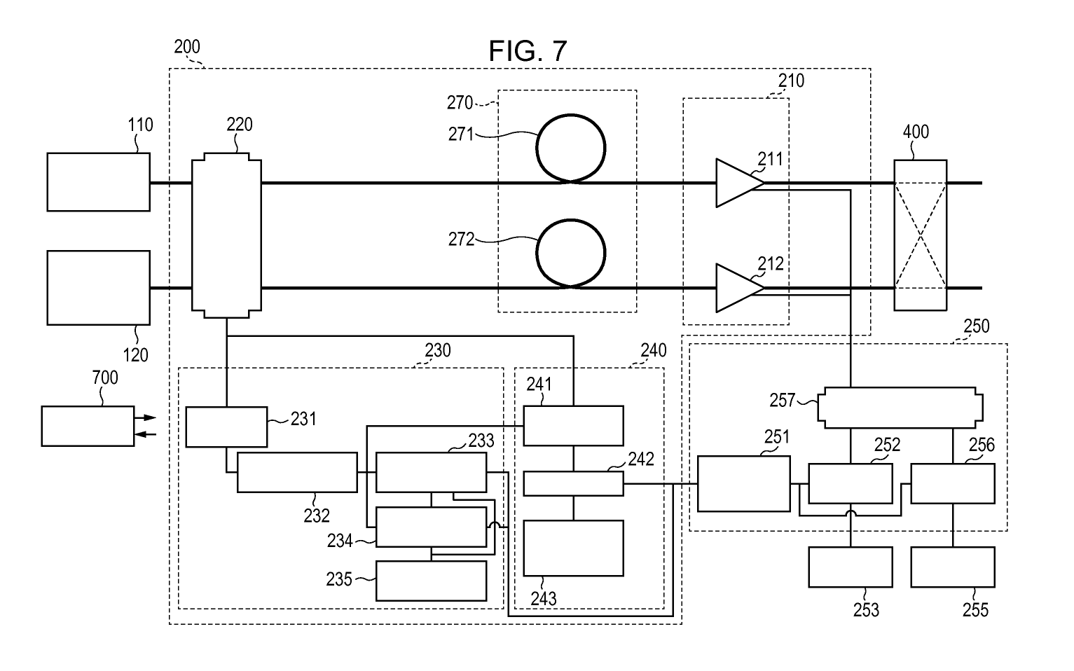

FIG. 7 is a schematic diagram that illustrates an optical transmission apparatus according to a technology discussed herein. In this embodiment, an excitation laser 255, an optical switch 256, and an optical multiplexer 257 are used in addition to the excitation laser 253 and optical switch 252 of the first embodiment. The rest of the structure is the same as that of the first embodiment. The optical multiplexer 257 multiplexes an excitation laser beam output from the excitation laser 253 and an excitation laser beam output from the excitation laser 255 and supplies a resulting laser beam to the optical fiber amplifiers 211 and 212. For example, an optical coupler is preferably used as the optical multiplexer 257. In the case where a single excitation laser is used, when the density of optical burst signals becomes higher, there is a possibility that the optical output power of the excitation laser becomes insufficient. A sufficient optical output power may be achieved by providing a plurality of excitation lasers. Even in the case where the signal density of optical burst signals becomes 100%, a sufficient amplification factor may be obtained.

### Fourth Embodiment

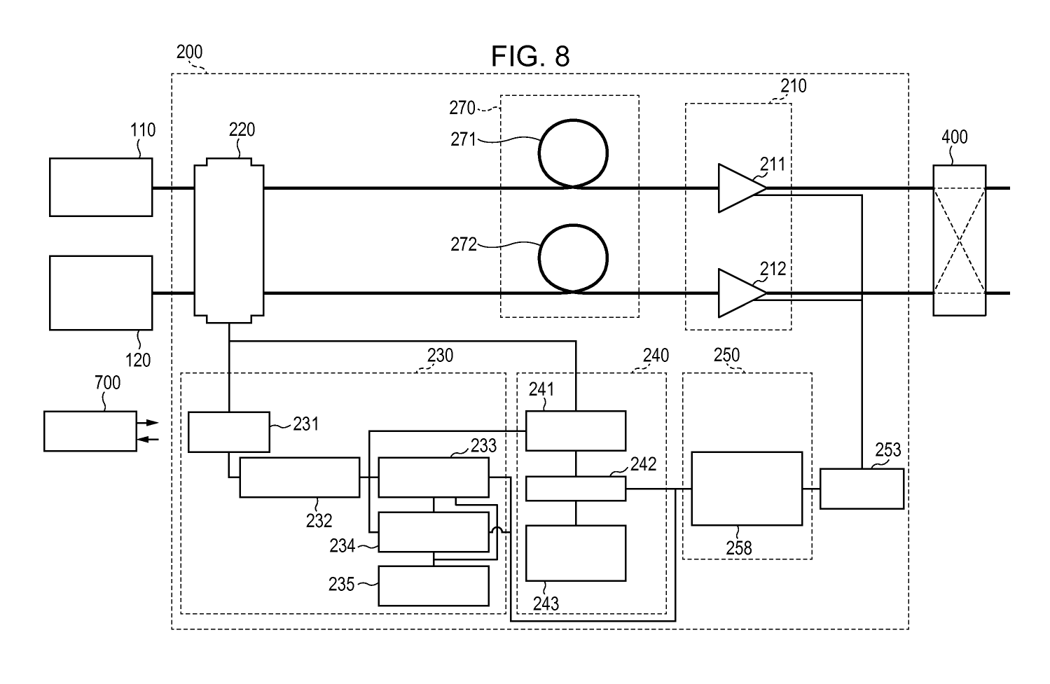

FIG. 8 is a schematic diagram that illustrates an optical transmission apparatus according to a technology discussed herein. In this embodiment, an optical laser current/voltage controller 258 that controls a current to be supplied to and a voltage to be applied to the excitation laser 253 is used instead of the optical switch controller 251 and optical switch 252 of the first embodiment. The rest of the structure is the same as that of the first embodiment. In the first embodiment, the optical power of the laser beam output from the excitation laser 253 does not change over time, and the optical power of the excitation laser beam to be input to the optical fiber amplifiers 211 and 212 is controlled by controlling the transmittance of the optical switch 252. In contrast, in this embodiment, increasing or decreasing of the optical power of an excitation laser beam is performed, in accordance with the signal densities and optical power of optical burst signals, by increasing or decreasing the optical power of a laser beam output from the excitation laser 253. The optical power of the laser beam output from the excitation laser 253 is controlled by controlling a current to be supplied to or a voltage to be applied to the excitation laser 253 from the optical laser current/voltage controller 258. In comparison with the first to third embodiments, cost reduction may be realized with the structure of this embodiment because the optical switches 252 and 256 and the acousto-optical switch 254 are not used. Note that, since there is a time lag after a current to be supplied or a voltage to be applied is changed until the output of the excitation laser 253 changes, the delay fibers 271 and 272 in the optical delay unit 270 are longer than those of the first to third embodiments.

The optical amplification unit 200, which includes the optical fiber amplifiers 211 and 212, has been described in the first to fourth embodiments. The optical amplification unit 500, which includes the optical amplifiers 510 and 520, has the same structure as the optical amplification unit 200.

Structures obtained by combining some of the first to fourth embodiments may be used in the technologies discussed herein.

In the first to fourth embodiments described above, gain control may be performed in accordance with the change in the optical power input to the optical amplification unit in the case where the density of packets changes. Thus, the optical power output from the optical amplification unit may be unlikely to change. As a result, even in the case where the density of optical packet signals becomes high, transmission performance improves since the optical signal-to-noise ratio (OSNR) is unlikely to decrease. Furthermore, the optical power output from the optical amplification unit is unlikely to change due to the change in the density of optical packet signals, and thus the range of the power input to the optical packet receiver is reduced. As a result, the optical packet signals may be farther transmitted.

The embodiments, which are typical of the technologies discussed herein, are described above; however, the technologies discussed herein are not limited to the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission apparatus comprising:
a splitter configured to split an input optical signal into a first optical signal and a second optical signal;
a signal length determiner configured to determine a signal length of the first optical signal per unit time;
an optical power detector configured to detect an optical power of the first optical signal per unit time;
a delay unit configured to delay the second optical signal;
an optical amplifier configured to amplify the second optical signal delayed by the delay unit;
a first excitation light source configured to generate an excitation light to be supplied to the optical amplifier; and
a first excitation light power adjustor configured to adjust an optical power of the excitation light to be supplied to the optical amplifier in accordance with the signal length of the first optical signal and the optical power of the first optical signal.

2. The optical transmission apparatus according to claim 1,
wherein the optical power of the excitation light to be supplied to the optical amplifier is adjusted in accordance with an average optical power of first optical signals each unit time

3. The optical transmission apparatus according to claim 1, further comprising:
a calculator configured to calculate proportions of first optical signals each unit time,
wherein the optical power of the excitation light to be supplied to the optical amplifier is adjusted in accordance with the proportions of the first optical signals each unit time in a case where the first optical signals each unit time have a same optical power.

4. The optical transmission apparatus according to claim 1,
wherein the optical power of the first optical signal per unit time is detected only in a time period in which the first optical signal per unit time exists.

5. The optical transmission apparatus according to claim 1,
wherein supplying of an excitation light to the optical amplifier is continued even in a signal interval between first optical signals each unit time in a case where the signal interval is shorter than a time period obtained by adding a time period in which excitation is insufficiently performed by the optical amplifier after supplying of the excitation light to the optical amplifier is started and a time period in which excitation is performed by fluorescence after supplying of the excitation light to the optical amplifier is stopped.

6. The optical transmission apparatus according to claim 1,
wherein the first excitation light power adjustor adjusts the optical power of the excitation light to be supplied to the optical amplifier while the first excitation light source is active.

7. The optical transmission apparatus according to claim 1,
wherein the first excitation light power adjustor adjusts the optical power of the excitation light to be supplied to the optical amplifier while the optical power of the excitation light generated by the first excitation light source does not change over time.

8. The optical transmission apparatus according to claim 7,
wherein the first excitation light power adjustor includes one of an optical switch using a PLZT thin film and a Mach-Zehnder type optical switch.

9. The optical transmission apparatus according to claim 7,
wherein the first excitation light power adjustor includes an acousto-optical switch.

10. The optical transmission apparatus according to claim 1,
wherein the first excitation light power adjustor adjusts the optical power of the excitation light to be supplied to the optical amplifier by changing the optical power of the excitation light output from the first excitation light source.

11. The optical transmission apparatus according to claim 1, further comprising:
a second excitation light source configured to generate an excitation light to be supplied to the optical amplifier;
a second excitation light power adjustor configured to adjust an optical power of the excitation light output from the second excitation light source and to be supplied to the optical amplifier, in accordance with the signal length of the first optical signal and the optical power of the first optical signal; and
a multiplexer configured to multiplex the excitation light output from the first excitation light source and the excitation light output from the second excitation light source.

12. An optical transmission method comprising:
splitting an input optical signal into a first optical signal and a second optical signal;
determining a signal length of the first optical signal per unit time;
detecting an optical power of the first optical signal per unit time;
delaying the second optical signal;
controlling an optical power of an excitation light to be supplied to an optical amplifier in accordance with the signal length of the first optical signal and the optical power of the first optical signal; and
amplifying the delayed second optical signal by using the controlled optical amplifier.

13. The optical transmission method according to claim 12,
wherein the optical power of the excitation light to be supplied to the optical amplifier is adjusted in accordance with an average optical power of first optical signals each unit time.

14. The optical transmission method according to claim 12,
wherein a proportion of first optical signals each unit time is obtained and the optical power of the excitation light to be supplied to the optical amplifier is adjusted in accordance with the proportion of the first optical signals each unit time in a case where the first optical signals each unit time have a same optical power.
